(19) United States
(12) Patent Application Publication
(10) Pub. No.: US 2009/0049852 A1
(43) Pub. Date: Feb. 26, 2009

(54) Ejector-type air-conditioning and refrigerating system for automotive vehicle

(75) Inventors: Mika Gocho, Obu-city (JP); Hiroshi Oshitani, Toyota-city (JP); Yoshiaki Takano, Kosai-city (JP); Satoshi Sumiya, Takahama-city (JP); Naoshi Sugesawa, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/228,679

(22) Filed: Aug. 13, 2008

(30) Foreign Application Priority Data
Aug. 20, 2007 (JP) 2007-213912

(51) Int. Cl. B60H 1/32; F25B 1/00; F25B 39/02; F25B 41/00; F25D 23/00

(52) U.S. Cl. 62/239; 62/498; 62/515; 62/513; 62/296

(57) ABSTRACT

An ejector-type air-conditioning and refrigerating system according to the present invention is mounted on an automotive vehicle. The system includes a first evaporator for cooling a passenger compartment and a second evaporator for cooling a refrigerator mounted on the vehicle. Refrigerant is supplied to the first evaporator through an ejector, while the refrigerant is supplied to the second evaporator through a restrictor disposed in a branch passage. Refrigerant evaporated in the second evaporator is sucked by a sucking portion provided in the ejector through a sucking passage. A noise dissipater for suppressing noises caused by pulsating vibrations generated in the ejector is disposed in the sucking passage at a position close to the sucking portion of the ejector. The noise dissipater is postured in the sucking passage so that liquid components in the refrigerant including oil contained in the refrigerant are prevented from being retained in the dissipater.

### CROSS-REFERENCE TO RELATED APPLICATION

This application is based upon and claims benefit of priority of Japanese Patent Application No. 2007-213912 filed on Aug. 20, 2007, the content of which is incorporated herein by reference.

### BACKGROUND OF THE INVENTION

1. Field of the Invention

The present invention relates to an air-conditioning and refrigerating system for an automotive vehicle including an ejector that functions as a device for depressurizing and circulating refrigerant.

2. Description of Related Art

An example of an ejector-type air-conditioning system having plural evaporators is disclosed in JP-A-2006-125823. In this system, a first evaporator is disposed between a downstream end of a diffuser and an upstream end of a compressor, and a branch passage for leading refrigerant to a second evaporator is branched out from a junction between the ejector and a radiator. A second evaporator and a restrictor are disposed in the branch passage. Both evaporators are positioned in a passenger compartment. The first evaporator is used for air-conditioning a passenger compartment, and the second evaporator is used for cooling a refrigerator.

FIG. 8 (attached hereto) is a schematic drawing for explaining a cause of generation of noises in the refrigerator 19 in which the second evaporator 18 is disposed. A downstream end of the second evaporator 18 is connected to a refrigerant-sucking portion 14c of the ejector through a sucking passage 16c. When pulsating vibrations are generated due to a disturbance of a refrigerant flow at a nozzle outlet of the ejector 14, the pulsating vibrations are transferred to the second evaporator 18 through the sucking passage 16c and are amplified by a casing 19a of the refrigerator 19. If this occurs, noises in the refrigerator 19 are transmitted to outside.

FIGS. 9 and 10 show another cause of noise generation. FIG. 9 shows a situation where the compressor is stopped, and FIG. 10 shows a situation where the compressor is started again. When the compressor is stopped, the refrigerant flows through the sucking passage 16c in a reverse direction, i.e., from the ejector 14 to the second evaporator 18. In addition, temperature of the first evaporator 15 becomes high while temperature in the refrigerator 19 is kept low. Accordingly, there is a tendency that liquid refrigerant and oil contained in the refrigerant are retained in the second evaporator 18 (refer to FIG. 9).

When the compressor is started again under this situation, the liquid refrigerant and oil retained in the second evaporator 18 and the sucking passage 16c are rapidly sucked by the sucking portion 14c of the ejector 14, rushing toward the ejector 14. The liquid refrigerant and oil hit a corner in the sucking passage 16c, and thereby vibrations are generated. The vibrations are transferred to the second evaporator 18 through the sucking passage 16c and amplified at the casing 19a of the refrigerator 19. Thus, noises are generated in the refrigerator 19 and/or in the sucking passage 16c (refer to FIG. 10).

The noises generated in the second evaporator 18 include continuous noises having relatively high frequencies which are caused by vibrations, and intermittent noises having relatively low frequencies which are caused when gaseous refrigerant flows out of the second evaporator.

### SUMMARY OF THE INVENTION

The present invention has been made in view of the above-mentioned problem, and an object of the present invention is to provide an improved ejector-type air-conditioning and refrigerating system, in which noises generated in the system including an ejector, a second evaporator and a sucking passage are suppressed.

The ejector-type air-conditioning and refrigerating system according to the present invention is mounted on an automotive vehicle. The system includes many components: a compressor for compressing refrigerant circulated in the system; a radiator for cooling high-pressure refrigerant delivered from the compressor; a first evaporator for cooling a passenger compartment; an ejector for supplying coolant to the first evaporator; a second evaporator for refrigerating a refrigerator mounted on the vehicle; and other associated components. The ejector is composed of a nozzle for depressurizing the high-pressure refrigerant delivered from the radiator, a sucking portion for sucking refrigerant from the second evaporator by means of a high-speed refrigerant flow injected by the nozzle, and a diffuser for converting velocity energy of the injected refrigerant and the sucked refrigerant to pressure energy.

The refrigerant supplied to the first evaporator from the ejector is evaporated in the first evaporator, thereby cooling the passenger compartment. The gaseous refrigerant evaporated in the first evaporator is fed to the compressor that compresses the refrigerant again to repeat the circulation of the refrigerant in the system. Part of the refrigerant delivered from the radiator is branched out to a branch passage. The refrigerant is supplied to the second evaporator through a restrictor disposed in the branch passage. The refrigerant is evaporated in the second evaporator to cool the refrigerator and then fed to the ejector through a sucking passage 16c.

A noise dissipater is disposed in the sucking passage at a position close to the sucking portion of the ejector. Pulsating vibrations generated in the ejector and amplified in the second evaporator and the sucking passage are dissipated by the noise dissipater. The noise dissipater is postured so that liquid, such as liquid refrigerant and oil contained in the refrigerant, is not retained in the noise dissipater. In this manner, the noises otherwise caused by the retained liquid when the compressor is re-started are suppressed. A valve device, such as an electromagnetic valve or a one-way valve, may be disposed between the sucking portion of the ejector and the noise dissipater to prevent the liquid refrigerant from flowing into the second evaporator when the compressor is not in operation.

A bypass restrictor for controlling an amount of refrigerant supplied to the first evaporator may be disposed between the radiator and the first evaporator in parallel to the ejector. By adding the bypass restrictor, the ejector can be more freely designed without considering a function for controlling an amount of the refrigerant to be supplied to the first evaporator. On outer surfaces of the noise dissipater, the ejector and the sucking passage may be covered with a heat-insulating layer to prevent water from condensing on the outer surfaces.

According to the present invention, noises caused by pulsating vibrations in the ejector or caused by liquid retained in the second evaporator are effectively suppressed. Other objects and features of the present invention will become more readily apparent from a better understanding of the preferred embodiments described below with reference to the following drawings.

### BRIEF DESCRIPTION OF THE DRAWINGS

FIG. 1 is a block diagram showing an ejector-type air-conditioning and refrigerating system as a first embodiment of the present invention;

FIG. 2 is a perspective view showing the same system as shown in FIG. 1, the system being mounted on an automotive vehicle;

FIG. 3 is a schematic view showing a sucking passage and components connected thereto in the first embodiment shown in FIG. 1;

FIG. 4 is a schematic view showing a sucking passage and components connected thereto in a second embodiment of the present invention;

FIG. 5 is a schematic view showing a sucking passage and components connected thereto in a third embodiment of the present invention;

FIG. 6 is a schematic view showing a sucking passage and components connected thereto in a fourth embodiment of the present invention;

FIG. 7 is a block diagram showing an ejector-type air-conditioning and refrigerating system as a fifth embodiment of the present invention;

FIG. 8 is a schematic view showing a cause of noise generation in a sucking passage of the system; and

FIGS. 9 and 10 are schematic views showing another cause of noise generation in a sucking passage of the system, FIG. 9 showing when a compressor is stopped while FIG. 10 showing when the compressor is started again.

### DETAILED DESCRIPTION OF THE PREFERRED EMBODIMENTS

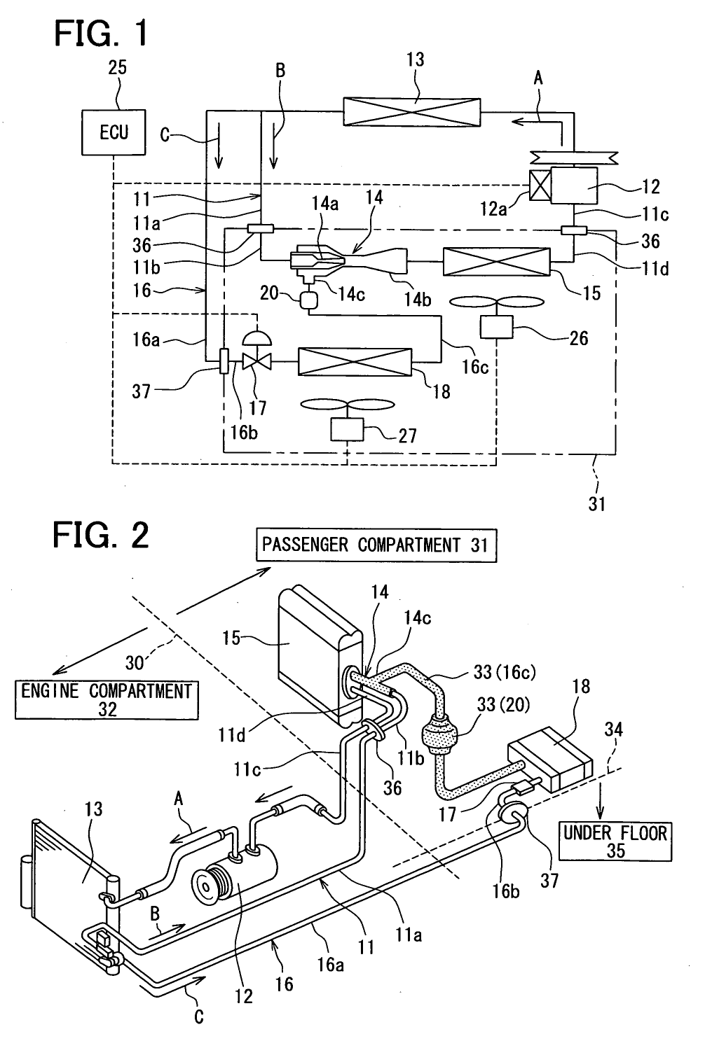

A first embodiment of the present invention will be described with reference to FIGS. 1-3. A compressor 12 for compressing refrigerant is disposed in a refrigerant passage and is driven by an engine of an automotive vehicle (not shown) through a driving belt. An amount of refrigerant delivered from the compressor 12 is controlled thereby to control cooling ability of the system. The compressor 12 used in this embodiment is a swash-plate-type compressor having a variable capacity. The capacity of the compressor 12 is controlled by changing a slanted angle of a swash-plate to thereby change a stroke of pistons driven by the swash-plate. The slanted angle of the swash-plate is controlled by an electromagnetic controller 12a.

High-pressure refrigerant delivered from the compressor 12 is sent to a radiator 13 which cools the refrigerant by exchanging heat between the refrigerant and outside air. The outside air is blown to the radiator 13 by a fan (not shown). An ejector 14 is disposed downstream of the radiator 13. The ejector 14 functions as a depressurizing device for depressurizing the refrigerant and as a device for circulating the refrigerant by drawing effect of the refrigerant injected through a nozzle in the ejector.

The ejector 14 is composed of: a nozzle 14a for depressurizing and expanding the high-pressure refrigerant under an equal entropy by squeezing a refrigerant; a sucking portion 14c, disposed at a same position as an injection outlet of the nozzle 14a, for sucking gaseous refrigerant from a second evaporator 18 (explained later); and a diffuser 14b disposed downstream of the sucking portion 14c for boosting pressure of the refrigerant. The diffuser 14b gradually enlarges the refrigerant passage to thereby decrease flow speed of the refrigerant and increase its pressure. In other words, the diffuser 14b coverts velocity energy of the refrigerant to pressure energy.

Liquid refrigerant depressurized in the ejector 14 is supplied to a first evaporator 15 that is contained in an air-conditioner unit disposed in the passenger compartment. The low-pressure liquid refrigerant is evaporated in the first evaporator 15 to thereby cool air in the passenger compartment. Air is blown to the first evaporator 15 by a first fan 26 to expedite heat exchange between the air and the refrigerant. The refrigerant evaporated in the first evaporator 15 is fed to the compressor 12 to be compressed therein. The compressed high-pressure refrigerant is supplied to the radiator 13 to be cooled therein and to be converted into liquid refrigerant again. The refrigerant is circulated repeatedly through the refrigerant passage 11.

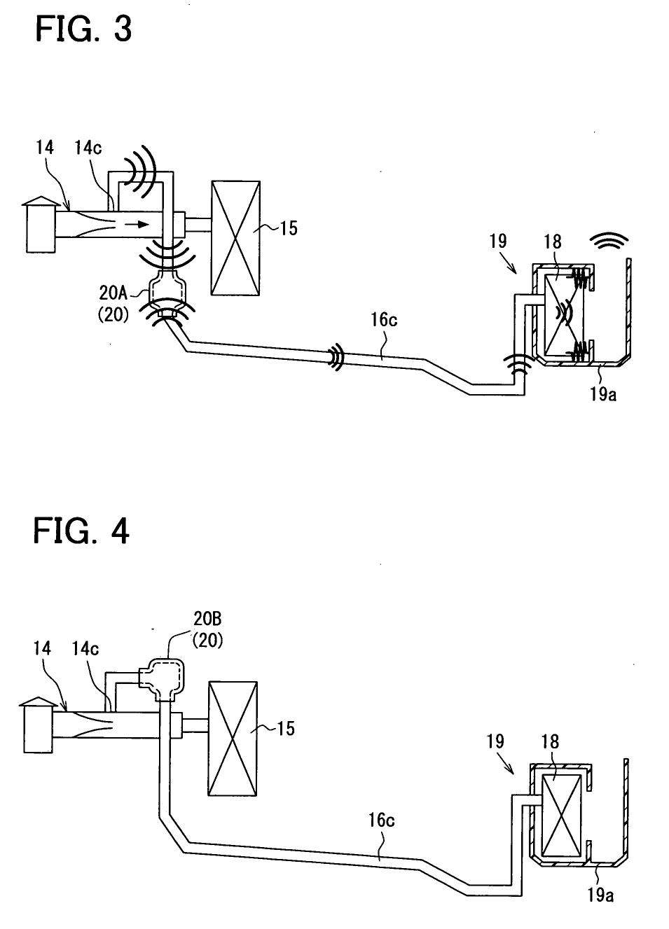

A branch passage 16 connecting a junction between the radiator 13 and the ejector 14 to the ejector 14 through a restrictor 17 and a second evaporator 18 is formed in this embodiment. The branch passage 16 includes a high pressure passages 16a, 16b connecting the radiator 13 to the restrictor 17 and a sucking passage 16c connecting an outlet of the second evaporator 18 to the ejector 14. The second evaporator 18 is disposed in a refrigerator casing 19a of a refrigerator 19 (refer to FIG. 3). The refrigerator 19 is disposed in the passenger compartment. The air in the refrigerator 19 is blown to the second evaporator 18 and cooled by the second evaporator 18.

The restrictor 17 is composed of a fixed orifice and an electromagnetic valve for opening and closing the fixed orifice. An amount of the refrigerant supplied to the second evaporator 18 is adjusted by the restrictor 17, and the refrigerant is depressurized by the restrictor 17. The restrictor 17 composed of the fixed orifice and the electromagnetic valve may be replaced with a single electromagnetic valve which is able to control a passage size to thereby control an amount of the refrigerant supplied to the second evaporator 18. Alternatively, the restrictor 17 may be provided by an expansion valve or a flow control valve. Further, for performing at least a depressurizing function, the restrictor 17 may be provided by an orifice or a capillary tube alone. The electromagnetic controller 12a for the compressor 12, the first fan 26, the second fan 27 and the electromagnetic valve in the restrictor 17 are all controlled by an electronic control unit (ECU) 25.

With reference to FIG. 2, how the ejector-type air-conditioning and refrigerating system is mounted on an automotive vehicle will be described. A dotted line 30 represents a dashboard separating an engine compartment 32 and a passenger compartment 31. The ejector 14, the first evaporator 15, the flow restrictor 17, the second evaporator 18, the first fan 26, and the second fan 27 are disposed in the passenger compartment 31, while the compressor 12 and the radiator 13 are disposed in the engine compartment 32. The refrigerator 19 is usually positioned inside an instrument panel. The ejector 14 is integrally connected to the first evaporator 15 in this embodiment. The refrigerator 19 is positioned close to a center console in the passenger compartment 31.

A cooling capacity of the first evaporator 15 is much larger than that of the second evaporator 18. The ejector 14 is positioned next to the first evaporator 15 having a large cooling capacity. A connector 36 is disposed on the dashboard 30. A high-pressure passage 11a in the engine compartment 32 is connected to a high-pressure passage 11b in the passenger compartment 31 through the connector 36. A low-pressure passage 11c in the engine compartment 32 is connected to a low-pressure passage lid in the passenger compartment 31 through the connector 36.

Since the ejector 14 and the refrigerator 19 are disposed in the passenger compartment 31, the sucking passage 16c connecting the refrigerator 19 and the ejector 14 are entirely disposed in the passenger compartment 31. Low-temperature refrigerant from the refrigerator 19 flows through the sucking passage 16c. If an outer surface of the metallic sucking passage 16c is exposed to the passenger compartment, water condenses on the outer surface. To prevent water from condensing on the outer surface of the sucking passage 16c, a heat-insulating layer 33 is formed on the outer surface. Further, an outer surface of the ejector 14 is covered with the same heat-insulating layer 33 because low-temperature refrigerant also flows through the ejector 14. The heat-insulating layer 33 is shown with small dots in FIG. 2. On the outer surface on the sucking passage 16c, a heat-insulating material such as a pipe-shaped insulator may be disposed. On the outer surface of the ejector 14, an heat-insulating material such as a plate-shaped packing member may be disposed. As the heat-insulating layer 33, a material such as foam resin may be used.

The restrictor 17 and the second evaporator 18 are positioned close to a floor plate 34 in the passenger compartment 31. A connector 37 is disposed through the floor plate 34. A high-pressure passage 16a disposed in an under-floor space 35 is connected to a high-pressure passage 16b disposed in the passenger compartment 31 through the connector 37. It is also possible to position the restrictor 17 in the under-floor space 35. Though the electronic control unit 25 is usually positioned in the passenger compartment 31, it is also possible to place it in the engine compartment 32.

With reference to FIG. 3 showing the sucking passage 16c connecting an outlet of the second evaporator 18 to the sucking portion 14c of the ejector 14, a noise dissipater 20 for absorbing pressure pulsation generated in the ejector 14 will be described. In this embodiment, a muffler 20A is used as the noise dissipater 20. The muffler 20A is disposed in the sucking passage 16c at a position close to the sucking portion 14c of the ejector 14. The muffler 20A is made of a material such as aluminum into a hollow pipe-shape having an inner diameter larger than that of the sucking passage 16c. Both ends of the muffler 20A is connected to the sucking passage 16c by soldering or the like. As shown in FIGS. 2 and 3, a center axis of the muffler 20A is positioned in the gravity direction to prevent liquid such as liquid refrigerant and oil contained in the refrigerant from being retained therein. An outer surface of the muffler 20A is covered with the heat-insulating layer 33 to prevent condensation of water thereon in the same manner as the outer surface of the sucking passage 16c.

Operation of the air-conditioning and refrigerating system described above will be explained. The compressor 12 is driven by an engine of an automotive vehicle. Low-pressure refrigerant is sucked into the compressor 12 to be pressurized therein. The pressurized refrigerant is supplied to the radiator 13 (in direction of an arrow A in FIGS. 1 and 2). The refrigerant is cooled in the radiator 13 and is condensed therein. The electromagnetic valve in the restrictor 17 is activated to open the restrictor 17 when the refrigerator is in use.

The high-pressure liquid refrigerant delivered from the radiator 13 flows through the refrigerant passage 11 (arrow B direction) and the branch passage 16 (in arrow C direction). The refrigerant flowing through the branch passage 16 is depressurized in the restrictor 17 and supplied to the second evaporator 18. The refrigerator 19 is cooled by evaporation of the refrigerant in the second evaporator 18. An amount of the refrigerant supplied to the second evaporator 18 is adjusted, independently from the refrigerant supplied to the first evaporator 15, by the restrictor 17 composed of the fixed orifice (such as a passage orifice or a capillary tube) and the electromagnetic valve. The refrigerating capacity of the refrigerator 19 is controlled by the amount of refrigerant supplied thereto and rotational speed of the second fan 27. The gaseous refrigerant outputted from the second evaporator 18 is sucked into the sucking portion 14c of the ejector 14 through the sucking passage 16c.

On the other hand, the high-pressure refrigerant flowing through the refrigerant passage 11 (in arrow B direction) is supplied to the ejector 14 and depressurized by the nozzle 14 and expanded. Pressure energy of the refrigerant is converted into velocity energy in the nozzle 14a. Accordingly, the refrigerant is injected at a high-speed from the nozzle 14a. The gaseous refrigerant supplied from the second evaporator 18 is sucked into the sucking portion 14c of the ejector 14 by a pressure drop in the high-speed refrigerant injected from the nozzle 14a.

Both of the refrigerant injected form the nozzle 14a and the refrigerant sucked by the sucking portion 14c join at an downstream end of the nozzle 14a and enter into the diffuser 14b. Since a passage in the diffuser 14 is enlarged, the velocity energy of the refrigerant entering into the diffuser 14 is converted into the pressure energy (i.e., the pressure of the refrigerant increases). The refrigerant outputted from the ejector 14 is supplied to the first evaporator 15. Air in the passenger compartment is cooled by evaporation of the refrigerant in the first evaporator 15.

The gaseous refrigerant evaporated in the first evaporator 15 is supplied again to the compressor 12 to repeat the refrigeration cycle described above. The cooling capacity of the first evaporator 15 is controlled by adjusting an amount of the refrigerant supplied from the compressor 12 and a speed of the first fan 26.

In the embodiment of the present invention described above, the refrigerant is supplied to the first evaporator 15 through the ejector 14 and to the second evaporator 18 through the restrictor 17. The passenger compartment 31 is air-conditioned by the first evaporator 15 and the refrigerator 19 is cooled at the same time. The refrigerant pressure supplied to the first evaporator 15 is the pressure pressurized by the diffuser 14b, while the refrigerant pressure supplied to the second evaporator 18 is the pressure depressurized by the restrictor 17. Therefore, the refrigerant pressure in the second evaporator 18 is lower than the refrigerant pressure in the first evaporator 15. Accordingly, the temperature in the passenger compartment is controlled to a relatively high temperature region while the temperature in the refrigerator 19 is controlled to a low temperature region.

As described above, the system of the present invention is able to perform two functions, i.e., air-conditioning the passenger compartment and refrigerating the refrigerator, at the same time by simply providing the branch passage 16 in the system. Further, the cooling capacity of the second evaporator 18 is controlled independently from the first evaporator 15. That is, the air-conditioning capacity of the first evaporator 15 is controlled by controlling the capacity of the compressor 12 and ability of the ejector 14 for injecting the refrigerant, while the cooling capacity of the second evaporator 18 is controlled by controlling the restrictor 17. In the case where the refrigerator 19 is not in use, the electromagnetic valve in the restrictor 17 is simply turned off to close the restrictor 17.

Since the muffler 20A is disposed in the sucking passage 16c at a position close to the sucking portion 14c of the ejector 14, the pressure pulsation generated in the ejector 14 is absorbed by the muffler 20A. Therefore, the pressure pulsation in the ejector 14 is prevented from being transmitted to the second evaporator 18, and noise generation in the second evaporator is suppressed.

Since the muffler 20A is postured so that its center axis is in the gravity direction, fluid such as fluid refrigerant and oil are prevented from being retained in the muffler 20A. Therefore, generation of intermittent noises having a relatively low frequency is prevented, while preventing generation of continuous noises having a relatively high frequency.

Since the outer surface of the muffler 20A and the sucking passage 16c is covered with the heat-insulating layer 33, water condensation on the outer surface is prevented. Since the muffler 20A is positioned at a position close to the sucking portion 14c of the ejector 14, the pressure pulsation in the ejector 14 is absorbed at a position close to the sucking portion 14c, and the generation of noises in the sucking passage 16c is suppressed.

A second embodiment of the present invention is shown in FIG. 4. In this embodiment, a muffler 20B, which is a little different from the muffler 20A in the first embodiment, is used. Other structures and functions of the second embodiment is the same as those in the first embodiment. A connecting portion of the muffler 20B to the sucking portion 14c is made at a substantially right angle with respect to its connecting portion to the sucking passage 16c. The connecting portion to the sucking passage 16c is directed to the gravity direction so that liquid is prevented from being retained in the muffler 20B.

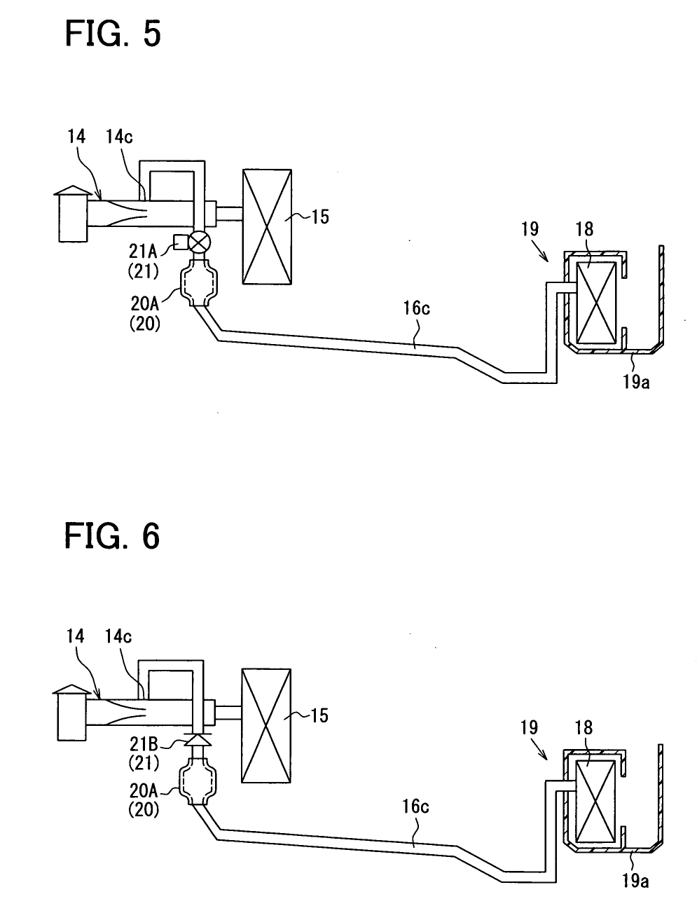

A third embodiment of the present invention is shown in FIG. 5. In this embodiment, an electromagnetic valve 21A as a valve device 21 is disposed between the sucking portion 14c of the ejector 14 and the muffler 20A. Other structures and functions are the same as those in the first embodiment. The electromagnetic valve 21A is closed when the compressor 12 is stopped to prevent liquid refrigerant to flow toward the second evaporator 18 and to be retained in the sucking passage 16c. By preventing retention of the liquid refrigerant in the sucking passage 16c, generation of noises when the compressor is re-started is prevented. The electromagnetic valve 21A is closed or opened in synchronism with stopping and starting the compressor 12. As shown in FIG. 5, the electromagnetic valve 21A is positioned above the muffler 20A at a position where the sucking passage 16c extends in the vertical direction. Therefore, a reverse flow of the liquid refrigerant toward the second evaporator 18 through the sucking passage 16c is prevented immediately after the sucking portion 14c of the ejector 14, and retention of the liquid refrigerant in the sucking passage 16c is effectively prevented.

A fourth embodiment of the present invention is shown in FIG. 6. In this embodiment, a one-way valve 21B permitting the refrigerant to flow only from the second evaporator 18 to the sucking portion 14c is used in place of the electromagnetic valve 21A. Other structures and functions are the same as those of the third embodiment.

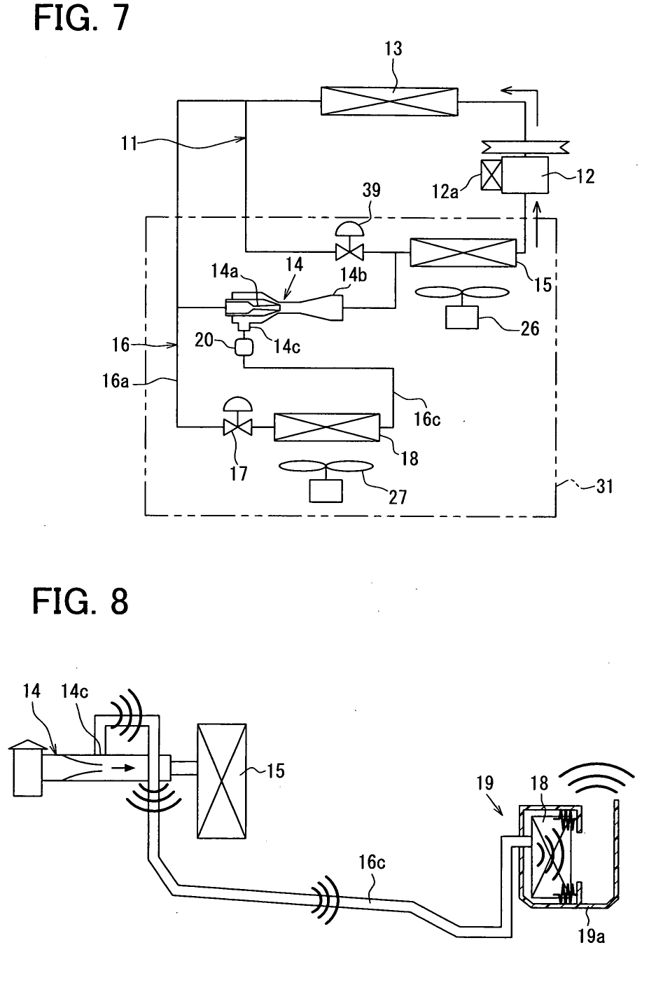

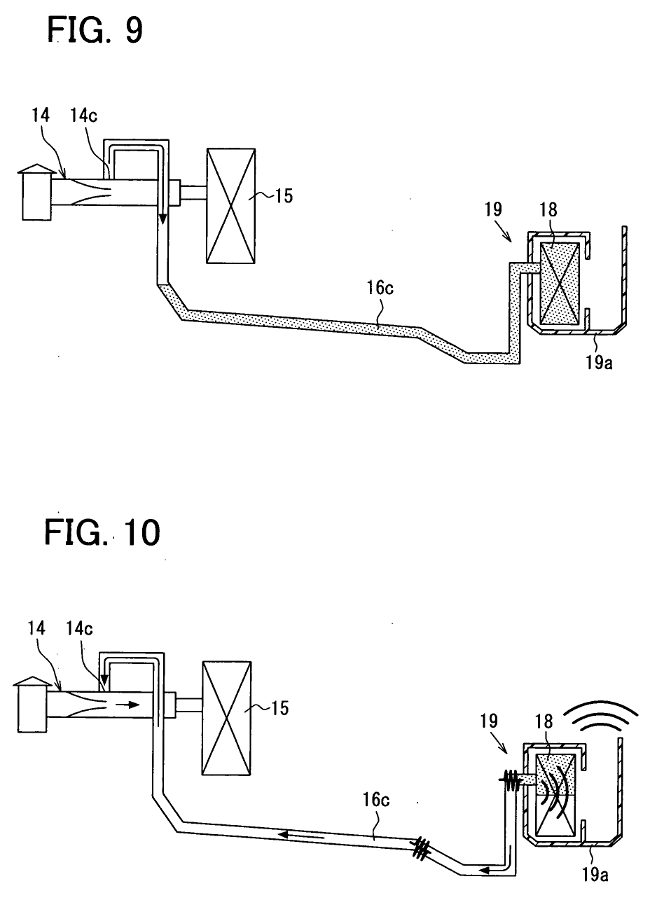

A fifth embodiment of the present invention will be described with reference to FIG. 7. In the foregoing embodiments, the refrigerant is supplied to the first evaporator 15 solely from the ejector 14. Therefore, the ejector 14 has to perform two functions, a function to adjust an amount of the refrigerant to be supplied to the first evaporator 15 and a pumping function to give a pressure difference between the refrigerant to be supplied to the first evaporator 15 and to the second evaporator 18. Accordingly, the ejector 14 has to be designed to meet specifications required by the first evaporator 15.

In the fifth embodiment, the ejector 14 is designed to perform only one function, the pumping function, and to improve efficiency of the ejector cycle. For this purpose, a bypass restrictor 39 for adjusting an amount of the refrigerant to be supplied to the first evaporator 15 is added in parallel to the ejector 14. A temperature-responsive expansion valve for maintaining temperature of an inlet portion of the first evaporator 15 at a predetermined temperature is used as the bypass restrictor 39 in this embodiment, though various kinds of valves may be used. Other structures of the fifth embodiment are substantially the same as those of the first embodiment.

The second evaporator 18 is disposed in the branch passage 16 through the restrictor 17 in the same manner as in the first embodiment. The outlet of the second evaporator 18 is connected to the sucking portion 14c of the ejector 14 through the noise dissipater 20 in the same manner as in the first embodiment. The outlet port of the diffuser 14b is connected to the first evaporator 15. It is also possible to connect the outlet port of the diffuser 14b to the outlet port of the first evaporator 15. The bypass restrictor 39 preferably includes a valve, which enables switching refrigerant source for the first evaporator 15. The bypass restrictor 39 may be replaced by valves which are able to electrically adjust a passage area of the refrigerant, such as an expansion valve and a flow control valve. The bypass restrictor 39 may be provided by an orifice or a capillary tube.

The present invention is not limited to the embodiments described above, but it may be variously modified. Some examples of the modifications are listed below. (1) Both of the first evaporator 15 and the second evaporator 18, each having different evaporation temperature of the refrigerant, may be used for air-conditioning the passenger compartment. (2) Both of the first evaporator 15 and the second evaporator 18 may be used for the refrigerator 19. That is, the first evaporator 15 having a higher refrigerant evaporation temperature may be used for cooling a storage space, and the second evaporator 18 having a lower refrigerant evaporation temperature may be used for refrigerating a refrigerating space. (3) The various refrigerant, such as flon, HC-type substitute flon or carbon dioxide, may be used as the refrigerant in the system. Though a device for separating liquid from gas in the refrigerant is not used in the foregoing embodiments, such a device may be disposed at a downstream end of the radiator 13. (4) Though a variable-capacity compressor 12 is used in the foregoing embodiment, it is possible to use a fixed-capacity compressor. In this case, an amount of refrigerant to be delivered from the compressor may be controlled by turning on or off an electromagnetic clutch disposed in the compressor. It is also possible to use a compressor that is driven by an electric motor. In this case, an amount of the refrigerant delivered from the compressor is controlled by controlling rotational speed of the motor. (5) In the first and the fifth embodiments, an additional branch passage may be added in parallel to the branch passage 16, and a third evaporator may be disposed in the additional branch passage. In this case, the diffuser 14b may be connected to an inlet port of the third evaporator. As the ejector 14, an ejector, in which a refrigerant passage area in the nozzle 14a is adjustable to adjust an amount of refrigerant flow therein, may be used. (6) Though the noise dissipater 20 and the valve device 21 are disposed in the sucking passage 16c in the foregoing embodiments, they may be disposed in the sucking portion 14c of the ejector 14 or at an outlet portion of the second evaporator 18. The noise dissipater 20 may be formed integrally with the sucking portion 14c of the ejector 14.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An ejector-type air-conditioning and refrigerating system for an automotive vehicle, comprising:
a compressor for compressing refrigerant;
a radiator for cooling high-pressure refrigerant delivered from the compressor;
an ejector disposed downstream of the radiator, the ejector including a nozzle for depressurizing and expanding the refrigerant delivered from the radiator, a sucking portion for sucking outside refrigerant by a high-speed refrigerant flow injected from the nozzle, and a diffuser for converting velocity energy of a refrigerant flow that includes the high-speed refrigerant flow injected from the nozzle and the refrigerant sucked by the sucking portion to pressure energy;
a first evaporator connected between the diffuser of the ejector and an upstream end of the compressor;
a branch passage connected between a downstream end of the radiator and the sucking portion of the ejector;
a restrictor, disposed in the branch passage, for depressurizing the refrigerant delivered from the radiator; and
a second evaporator disposed downstream of the restrictor in the branch passage; wherein:
a portion of the branch passage between the second evaporator and the sucking portion forms a sucking passage; and a noise dissipater for dissipating pulsating noises generated in the system is disposed in the sucking passage.

2. The ejector-type air-conditioning and refrigerating system as in claim 1, further including a bypass restrictor, disposed between the radiator and the first evaporator in parallel to the ejector, for depressurizing the refrigerant delivered from the radiator and for controlling an amount of refrigerant supplied to the first evaporator.

3. The ejector-type air-conditioning and refrigerating system as in claim 1, wherein the noise dissipater is postured in the sucking passage so that liquid refrigerant and oil contained in refrigerant are prevented from being retained in the noise dissipater.

4. The ejector-type air-conditioning and refrigerating system as in claim 1, wherein a heat-insulating layer is formed on outer surface of the noise dissipater.

5. The ejector-type air-conditioning and refrigerating system as in claim 1, wherein a valve device for opening or closing the sucking passage is disposed in the sucking passage, and the valve device is closed when the compressor is stopped.

6. The ejector-type air-conditioning and refrigerating system as in claim 5, wherein the valve device is an electromagnetic valve.

7. The ejector-type air-conditioning and refrigerating system as in claim 5, wherein the valve device is an one-way valve.

8. The ejector-type air-conditioning and refrigerating system as in claim 1, wherein the noise dissipater is positioned close to the sucking portion of the ejector.

9. The ejector-type air-conditioning and refrigerating system as in claim 5, wherein the valve device is positioned close to the sucking portion of the ejector.

10. The ejector-type air-conditioning and refrigerating system as in claim 5, the valve device is disposed between the sucking portion of the ejector and the noise dissipater.

11. The ejector-type air-conditioning and refrigerating system as in claim 4, wherein the heat-insulating layer is further formed on outer surfaces of the ejector and the sucking passage.
